(19) United States
(12) Patent Application Publication
(10) Pub. No.: US 2026/0368530 A1
(43) Pub. Date: Nov. 19, 2026

(54) LARGE LANGUAGE MODELS TRAINING DATA FILTERING

(71) Applicant: International Business Machines Corporation, Armonk, NY (US)

(72) Inventors: Hajar Emami Gohari, Plano, TX (US); Xuan-Hong Dang, Chappaqua, NY (US); SYED YOUSAF SHAH, YORKTOWN HEIGHTS, NY (US); Bishwaranjan Bhattacharjee, YORKTOWN HEIGHTS, NY (US); Nirmit V Desai, YORKTOWN HEIGHTS, NY (US); David Cox, Somerville, MA (US); Petros ZERFOS, New York, NY (US)

(73) Assignee: International Business Machines Corporation, Armonk, NY (US)

(21) Appl. No.: 19/206,974

(22) Filed: May 13, 2025

(51) Int. Cl. G06N 3/0895

(52) U.S. Cl. CPC G06N 3/0895

(57) ABSTRACT

An embodiment includes sampling form sample domain data, representative of data pertaining to a domain, wherein the sample domain data comprises a set of documents. The embodiment includes establishing, a statistical distribution of the set of documents according to a readability metric of each document in the set of documents based on the domain. The embodiment includes causing the machine learning model to output a performance metric. The embodiment includes modifying, the machine learning model. The embodiment includes filtering, the subset of documents from the sample domain data such that a second subset comprising documents remaining in the sample domain data after the extracting comprises filtered data. The embodiment also includes adjusting of a parameter of the machine learning model based at least on a difference between the sample domain data and a previous sample domain data.

### BACKGROUND

The present invention relates generally to artificial intelligence. More particularly, the present invention relates to a method, system, and computer program for Large Language Model Training Data Filtering.

Artificial intelligence (AI) technology has evolved significantly over the past few years. Modern AI systems are achieving human-level performance on cognitive tasks like converting speech to text, recognizing objects and images, and translating between different languages. This evolution holds promise for new and improved applications in many industries.

A Large Language Model (LLM or model, plural LLMs or models) is a type of software designed to understand and generate human-like text. LLMs are trained on massive amounts of data from books, articles, websites, and other written sources. At their core, LLMs use a neural network in a transformer architecture that has layers of interconnected nodes that process and interpret text data. An Artificial Neural Network (ANN) is a computing system made up of a number of simple, highly interconnected processing elements, which process information by their dynamic state response to external inputs. ANNs are processing devices (algorithms and/or hardware) that are loosely modeled after the neuronal structure of the mammalian cerebral cortex but on smaller scales. A large ANN implementation of an LLM might have tens of millions of interconnected nodes. By comparison, a mammalian brain has billions of neurons with a corresponding increase in the magnitude of their overall interaction and emergent behavior.

Conventional AI techniques use large data sets to train LLMs and use the trained LLM to identify patterns and draw conclusions in response to inputs. For example, LLMs can analyze the context of the words in a sentence or passage by looking at how words relate to each other in terms of meaning and usage and generate relevant and coherent responses.

### SUMMARY

The illustrative embodiments provide for Large Language Model Training Data Filtering. An embodiment includes executing, a specially purposed sampling instruction by a domain sampling component, the executing causing sampling of raw data to form sample domain data, the sample domain data representative of data pertaining to a domain, wherein the sample domain data comprises a set of documents. The embodiment includes establishing, a statistical distribution of the set of documents, wherein the statistical distribution is according to a readability metric of each document in the set of documents based on the domain. The embodiment includes configuring, a computational component to operate with a machine learning model causing the machine learning model to iteratively execute a specially purposed training instruction on the sample domain data, the executing outputting a performance metric. The embodiment includes modifying, the machine learning model responsive to the performance metric being improved compared to a performance threshold, wherein the performance threshold is based on a benchmark dataset. The embodiment includes capturing, from the statistical distribution, a subset of documents such that each member of the subset has a value of the corresponding readability metric, and the value is below a first threshold configured for the statistical distribution. The embodiment includes filtering, the subset of documents from the sample domain data such that a second subset comprising documents remaining in the sample domain data after the extracting comprises filtered data. The embodiment also includes further configuring the computational component to cause adjustment of a parameter of the machine learning model based at least on a difference between the sample domain data and a previous sample domain data.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a diagram of an implementation of filtering for improving data quality in training large language models in accordance with an illustrative embodiment;

FIG. 3 depicts a diagram of an implementation of categorizing documents used in filtering for improving data quality in training large language models in accordance with an illustrative embodiment;

FIG. 4 depicts a diagram of an implementation of categorizing documents used in filtering for improving data quality in training large language models in accordance with an illustrative embodiment;

FIG. 5 depicts a diagram of an implementation of filtering for improving data quality in training large language models in accordance with an illustrative embodiment;

FIG. 6 depicts a graph of a performance of an implementation of filtering for improving data quality in training large language models in accordance with an illustrative embodiment;

FIG. 7 depicts a flow chart of an implementation of filtering for improving data quality in training large language models in accordance with an illustrative embodiment; and

FIG. 8 depicts a system diagram of an implementation of filtering for improving data quality in training large language models in accordance with an illustrative embodiment.

### DETAILED DESCRIPTION

The quality of an output of an LLM is highly dependent on the training of that LLM. Particularly, the quality of the data used to train an LLM can directly impact the quality – in terms of accuracy, applicability, currency, contextual appropriateness – of the output.

The illustrative embodiments recognize that the quality of data used to train LLMs becomes fundamental to their ability to comprehend and generate human-like text, uphold reliability, and promote fairness by mitigating bias. The illustrative embodiments recognize that the quality of the training data is one of the decisive factors in determining the performance of a language model. For example, the illustrative embodiments recognize that the training data quality improves an LLM’s capacity for generalization and cost efficiency by minimizing the necessity for retraining.

The illustrative embodiments recognize that high-quality training data can ensure that LLMs produce reliable information, avoiding or alleviating misleading generated outputs. Better training data leads to better trained models, better business insights, and can directly impact a business’s profitability.

The illustrative embodiments further recognize that better quality of training data can reduce the overall size of the training data and consequently reduce the computation resource needed to train LLMs. As an example, the illustrative embodiments recognize that smaller but more effectively selected training data can train the same model with less data, less energy, and less retraining, thereby contributing significantly towards reducing the environmental costs of AI. Therefore, the illustrative embodiments recognize that investing in and improving LLM training data quality is highly desirable in AI-driven initiatives.

Presently, some methods exist for reducing the training data, improving the quality of the training data, or both, and these methods have certain limitations and/or disadvantages that are solved, reduced, remedied, or alleviated by the illustrative embodiments described herein. For example, certain existing methods are limited to deduplication, removal of very small documents based on threshold document size or word count for inclusion in the training data, mean word size, symbol-to-word ratio, normalization of paragraphs in style, redundancy of content, or some combination of these and other such heuristics. The illustrative embodiments recognize that the present methods only look at the raw data when applying these heuristics and are therefore frequently less successful in filtering out certain low-quality documents for LLM training from the raw data corpus, which can be of marginal value as training data yet escape these heuristics and get included in the training data.

The illustrative embodiments address the deficiencies described herein and provide a process (as well as a system, method, and computer program product embodied in a machine- readable medium) for filtering the data collected for training an LLM. An embodiment can be used in conjunction with or as a substitute for an existing method for training data filtration. The illustrative embodiments utilize techniques described herein for the filtration of training data using not just the raw data but also readability metrics resulting therefrom. The combination of raw data and readability metrics, when used in a manner described herein, provides an improved manner of filtration of the training data for the benefits and advantages of LLM training, as described herein.

The illustrative embodiments provide for Large Language Model Training Data Filtering. Embodiments are disclosed herein with reference to Large Language Models as the term is understood presently – an ANN comprising millions of nodes. However, the use of this example size is not intended to be limiting but is instead used for descriptive purposes only. The illustrative embodiments can be used to filter any corpus of data in a similar manner without departing from the scope of the illustrative embodiments, whether used in conjunction with an LLM, a smaller model, or other AI applications. Machine learning models can learn through training, where data with known outcomes is inputted into the computer model, outputs regarding the data are compared to the known outcomes, and/or the weights of the computer model are autonomously adjusted based on the comparison to replicate the known outcomes.

Illustrative embodiments include executing, a specially purposed sampling instruction by a domain sampling component, the executing causing sampling of raw data to form sample domain data, the sample domain data representative of data pertaining to a domain, wherein the sample domain data comprises a set of documents.

As used herein, the term “specially purposed” may refer to specially purposed computer routines and specially purposed computer user interfaces. The specially purposed instruction may be software code that is associated with and takes the form of an application and/or specially purposed application programming interfaces (APIs) associated with the application and/or associated with an application server that works with the application to execute functions described herein.

Illustrative embodiments include establishing, a statistical distribution of the set of documents, wherein the statistical distribution is according to a readability metric of each document in the set of documents based on the domain.

Illustrative embodiments include configuring, a computational component to operate with a machine learning model causing the machine learning model to iteratively execute a specially purposed training instruction on the sample domain data, the executing outputting a performance metric.

Illustrative embodiments include modifying, the machine learning model responsive to the performance metric being compared to a performance threshold, wherein the performance threshold is based on a benchmark dataset.

Illustrative embodiments include capturing, from the statistical distribution, a subset of documents such that each member of the subset has a value of a corresponding readability metric, and the value is below a first threshold configured for the statistical distribution.

Illustrative embodiments include filtering, the subset of documents from the sample domain data such that a second subset comprising documents remaining in the sample domain data after the filtering comprises filtered data.

Illustrative embodiments also include further configuring the computational component to cause adjustment of a parameter of the machine learning model based at least on a difference between the sample domain data and a previous sample domain data.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

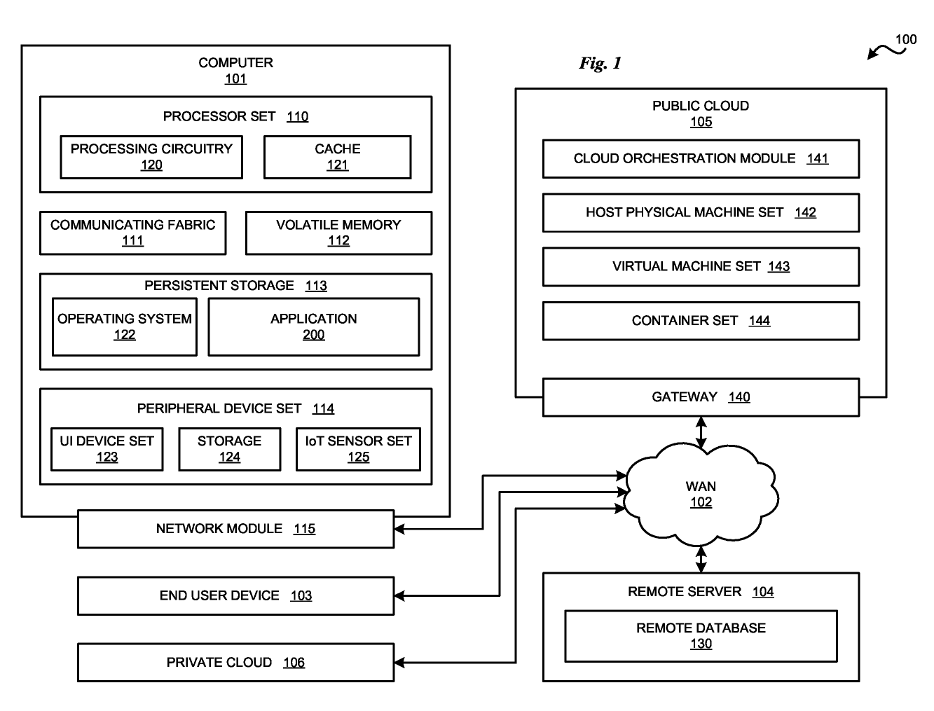

With reference to FIG. 1, this figure depicts a block diagram of a computing environment 100. Data center environment 100 contains an example of an environment for the execution of at least some of the computer code involved in performing the inventive methods, such as an Application 200 that provides Large Language Model Training Data Filtering. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made. Available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of Application Programming Interfaces (API). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

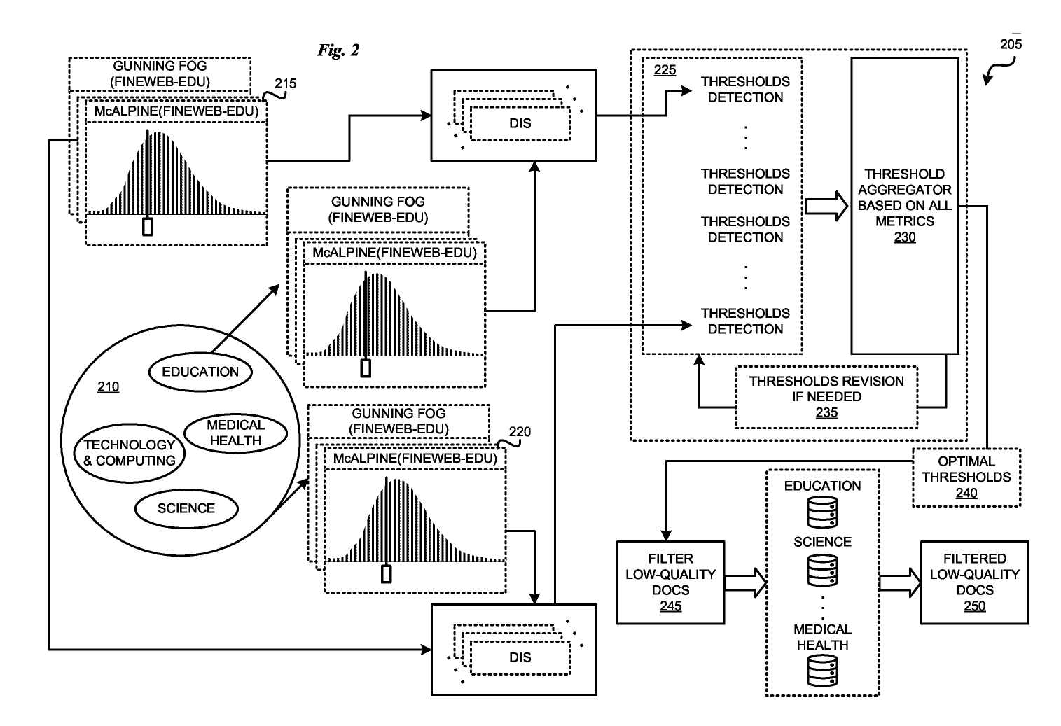

FIG. 2 depicts a diagram of an implementation of filtering for improving data quality in training large language models in accordance with an illustrative embodiment. In a particular embodiment, the components of diagram 205 show aspects of the Application 200 of FIG. 1.

In the illustrated embodiment, a domain sampling component of a system executes a sampling instruction, the executing causing sampling of raw data to form sample domain data, the sample domain data representative data pertaining to a domain, wherein the sample domain data comprises a set of documents. For example, raw data corpus 210 described herein may be sourced from any type and number of data sources, for example, data mart and/or Internet or other raw data source. One or more domains are identified in raw data corpus 210 to form raw domain data such as education, technology & computing, medical health and/or science. For example, raw domain data may comprise raw data pertaining to domain 1 through domain n. Raw domain data is a further optional form of raw domain data in which one or more categories and one or more subcategories have been identified and appropriately flagged or marshaled. For example, raw domain data is shown to include categories A-X for domain 1, and so on till domain n having categories P-T with category T having subcategories (i)-(x), and so on.

In embodiments, a component of the system establishes a statistical distribution of the set of documents, where the statistical distribution is according to a readability metric of each document in the set of documents based on the domain. A readability metric may be a readability metric using techniques such as Mcalpile EFLaw 215, which may be used as a reference readability metric, and/or other available techniques 220 including but not limited to Gunning Fog, Mcalpile EFLaw, Flesch Kincaid Grade Level, and/or Automated Readability Index (ARI). In an embodiment, the component computes a readability metric of a document in the set of documents. For example, using ARI, the component calculates a score based on the number of characters per word and the number of words per sentence within a text. The formula used for the ARI is: 4.71 * (total characters / total words) + 0.5 * (total words / total sentences) - 21.43. The readability metric including a score from the formula is then interpreted as an approximate grade level required for a reader to comprehend the text. Based on the scores of the set of documents, a statistical distribution, including but not limited to Gaussian, bell-shaped normal distribution, chi-square distribution and/or histograms of the set of documents is established.

In an embodiment, a component of the system detects, and determines from the statistical distribution a plurality of thresholds 225, the plurality of thresholds including the threshold and a second threshold. Starting from initial threshold values and subsequently using iteratively revised threshold values, the documents at the extremes of the distributions are removed at each iteration using threshold aggregation. Threshold aggregator 230 aggregates the thresholds for various readability scores operating on the same domain data to order or distribute the documents in an aggregate manner. Iterative threshold revisions 235 to one or more thresholds are computed in operations and utilized to arrive at optimized values of one or more thresholds, as the case may be depending on the number of domains in the data, type of distribution(s) used, readability scores used, or some combination of these and other factors. From the aggregate ordering or distribution of the documents the low-quality documents according to the aggregate thresholds are removed, extracted or filtered out.

The optimal threshold values 240 are supplied to an extracting application, that uses optimal threshold values on new raw domain data. Low quality documents according to the optimal thresholds are filtered out 245 from domain data to output filtered domain data 250.

In one embodiment, a component computes a distribution of the documents according to the readability metric of each document. For example, one nonlimiting example of the distribution may be a Gaussian distribution. The documents lying on either of the extreme ends of the Gaussian distribution may be regarded as low quality docs. Specifically, the documents lying beyond a threshold distance on either side from the mean of the Gaussian distribution may be regarded as the documents lying at the extremes. The component captures, extracts and filters the documents at the extremes of a distribution.

In order to identify the extremes, a component of the system according to an illustrative embodiment uses one or more threshold values. The number of threshold values is dependent on the type of distribution used, as described herein.

In embodiments, a component of the system captures, from the statistical distribution, a subset of documents such that each member of the subset has a value of the corresponding readability metric, and the value is below a first threshold configured for the statistical distribution.

Component extracts the documents that are in the extremes and produces interim filtered data. Component uses test LLM to determine whether the interim filtered data improves an output of test LLM. If test LLM provides a machine learning feedback such as a performance metric that the performance has improved, component may further tune a threshold to try and further improve the performance until the improvements either reverse or stagnate. For example, determining the performance metric being compared to the performance threshold comprises computing a statistical distance between the performance metric and the performance threshold. Computing a statistical distance may include known techniques such as Kullback–Leibler divergence. Similarly, if test LLM provides a machine learning feedback that the performance has deteriorated, such as an increased statistical distance, the component may roll back a threshold to a previous value or a different value to try and improve the performance.

Once the performance of test LLM is determined to be satisfactory, or further improvements not computationally desirable, component outputs a final version of filtered data in the form of filtered data. Filtered data is then usable for training production LLM.

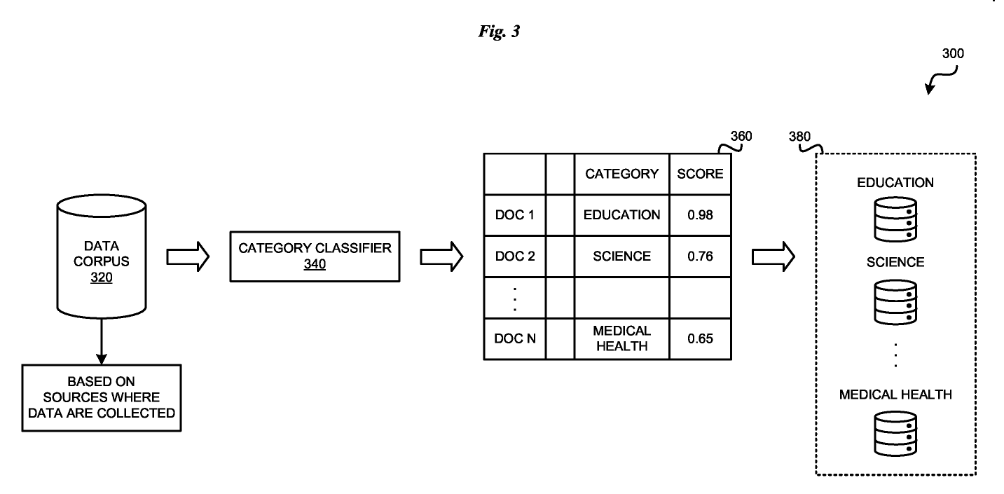

FIG. 3 depicts a diagram of an implementation of categorizing documents used in filtering for improving data quality in training large language models in accordance with an illustrative embodiment. In a particular embodiment, the components of diagram 300 show aspects of the Application 200 of FIG. 1.

In the illustrated embodiment, a component identifies, using one or more known methods, one or more knowledge domains (domain) to which a document in the raw data corpus 320 pertains. Processing the raw data in this manner, the embodiment creates domain data for one or more domains from the raw data corpus 360. For example, documents pertaining to education information may be categorized under the “Education” domain, whereas a health record file might be classified under a “Medical Health” domain.

An embodiment further applies one or more techniques to categorize the raw data within a domain (raw domain data). For example, one embodiment uses a clustering technique 340 to identify one or more categories in which the raw domain data of a particular domain might be separated. As an example, raw domain data of “Code” domain can be further categorized into “Java”, “C++”, “Python” and other language categories. A category might have one or more subcategories, and the depth of categorization may be any number of levels deep. Without implying any limitation, any number of domains, categories as well as subcategories may be applied to the raw data corpus.

The extreme filtration application filters out certain documents from the raw data corpus in a manner described herein and produces filtered data 380. The filtered data is usable for training a model as described herein.

In one embodiment, a component of the system comprises a data sampler. The data sampler samples the raw domain data of a domain to extract a representative sample of the raw domain data of the domain. The sample raw domain data is just a smaller data set from the raw domain data of the domain, such that the sample maintains substantially the same distribution, range, scope, and other attributes of the information contained in the raw domain data of that domain.

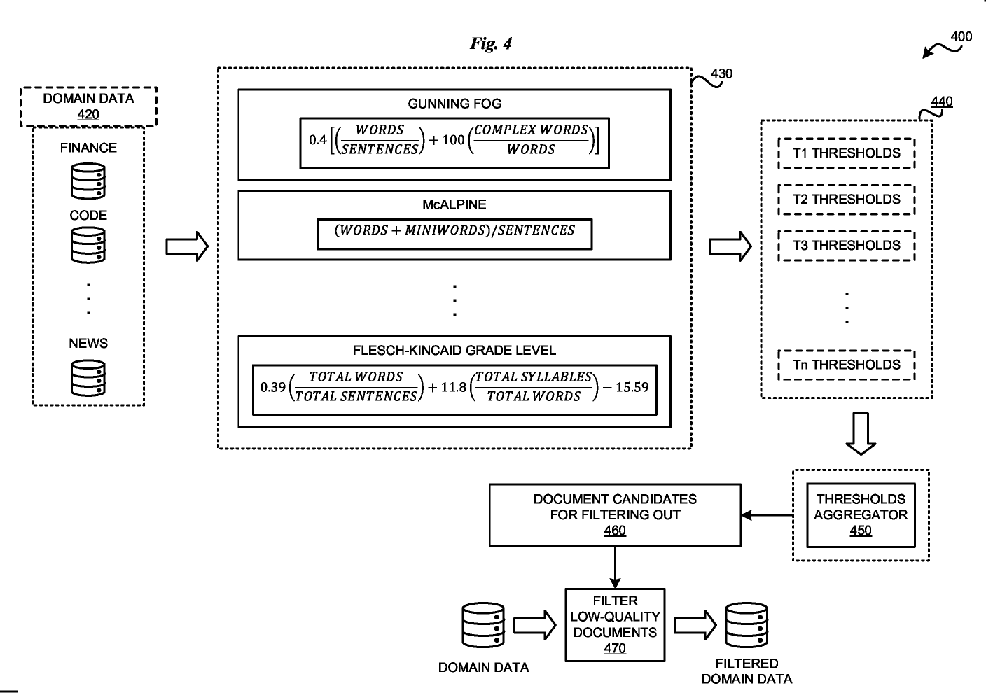

FIG. 4 depicts a diagram of an implementation of categorizing documents used in filtering for improving data quality in training large language models in accordance with an illustrative embodiment. In a particular embodiment, the components of diagram 400 show aspects of the Application 200 of FIG. 1.

In the illustrated embodiment, a readability metric of a document in the domain data 420 is determined. For example, a readability technique 430 such as Gunning Fog may determine the readability metric based on words, sentences and complex words.

The readability metric including a score from the technique is then interpreted as an approximate grade level required for a reader to comprehend the text. Based on the readability metric of the set of documents, a statistical distribution, including but not limited to Gaussian distribution, chi-square distribution and/or histograms of the set of documents is established.

In an embodiment, a component of the system detects, and determines from the statistical distribution a plurality of thresholds 440, the plurality of thresholds including the threshold and a second threshold. As described herein, starting from initial threshold values and subsequently using iteratively revised threshold values, the documents at the extremes of the distributions are removed at each iteration using threshold aggregation. Threshold aggregator 450 aggregates the thresholds for various readability scores operating on the same domain data to order or distribute the documents in an aggregate manner. Iterative threshold revisions to one or more thresholds are computed in operations and utilized to arrive at optimized values of one or more thresholds, as the case may be depending on the number of domains in the data, type of distribution(s) used, readability scores used, or some combination of these and other factors. From the aggregate ordering or distribution of the documents the low-quality documents according to the aggregate thresholds are removed, extracted or filtered out.

Once thresholds have been optimized for all the different distributions for all the different readability metrics for a given domain data, the process aggregates the threshold values for that sample domain data. For example, if for one sample domain data, one readability metric distribution identified documents A, B, C, and D for exclusion due to low quality, another readability metric distribution identified documents A, B, E, and X for exclusion, and another readability metric distribution identified documents A, B, and C for exclusion, aggregation step would identify the optimized aggregated threshold such that documents A and B are excluded and not C, D, E, or X (460). The process may also perform a ranking of the documents in the sample domain data. The process filters out, removes, makes unavailable, or otherwise excludes the extreme documents – documents lying outside of the optimized aggregated threshold 470. The process outputs the filtered data thus created.

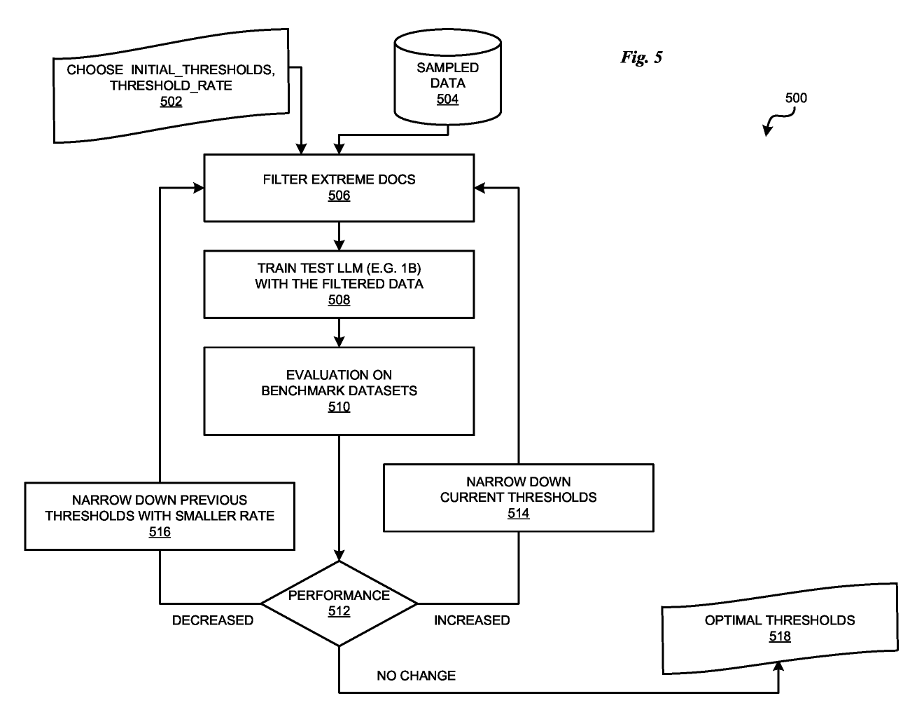

FIG. 5 depicts a diagram of an implementation of filtering for improving data quality in training large language models in accordance with an illustrative embodiment. In a particular embodiment, the components of diagram 500 show aspects of the Application 200 of FIG. 1.

In the illustrated embodiment, using the initial thresholds 502 and the sampled data 504, some extreme documents are filtered out (506) from the sampled data. The remaining documents form a filtered data set. A test LLM is trained using the filtered data set (508). In one example implementation, the test LLM is a small, 1.4 billion parameters model, but the test LLM may be of any suitable size or complexity without departing the scope of the illustrative embodiments.

The performance of the thus trained test LLM is evaluated using one or more benchmark dataset (510) to determine whether the filtered data set improved or decreased relative to the performance threshold using the benchmark data set (512). If the performance increased, the threshold value(s) used in the last iteration are narrowed, i.e., adjusted in a manner that more documents would fall outside the adjusted threshold and be filtered out as low quality as compared to the previous iteration (514). If the performance decreased, the threshold value(s) used in the last iteration are broadened, i.e., adjusted in a manner that fewer documents would fall outside the adjusted threshold and be filtered out as low quality as compared to the previous iteration (516).

A revised set of low-quality documents are filtered out (returning to 506) and the process 506-512 performed in another iteration. When the performance of the test LLM remains unchanged, to wit, not changing by more than a tolerance value in either direction relative to the performance in the previous iteration, the last used threshold value(s) are output as optimal threshold(s) (518).

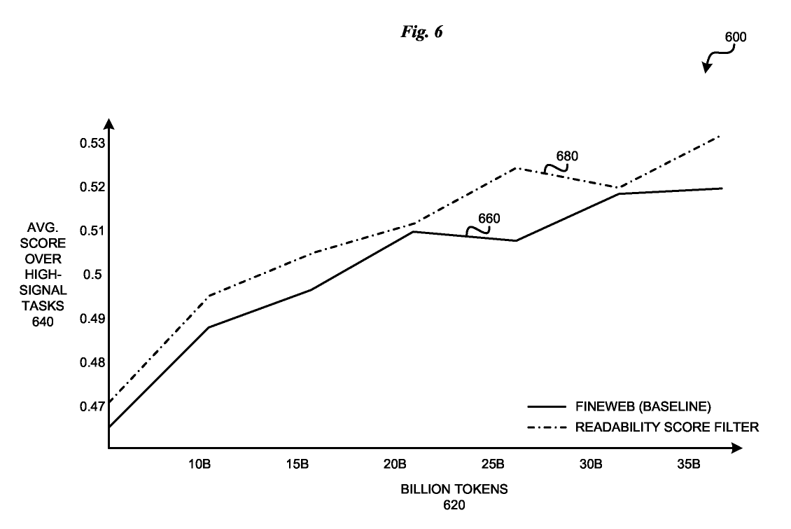

FIG. 6 depicts a graph of a performance of an implementation of filtering for improving data quality in training large language models in accordance with an illustrative embodiment. In a particular embodiment, the components of diagram 600 show aspects of the Application 200 of FIG. 1.

In the illustrated embodiment, a graph depicts the results of an ablation experiment comparing the performance of readability metric filtering against the FineWeb.V1.1 baseline at 1.4 billion parameter model size for 35 billion tokens. A plot of number of tokens in billions (or checkpoints) on the x-axis 620 against readability scores over high signal tasks on the y-axis 640 shows improved results of an implementation of the embodiments for readability score filtering 680 over the baseline (subset of FineWeb dataset) 660.

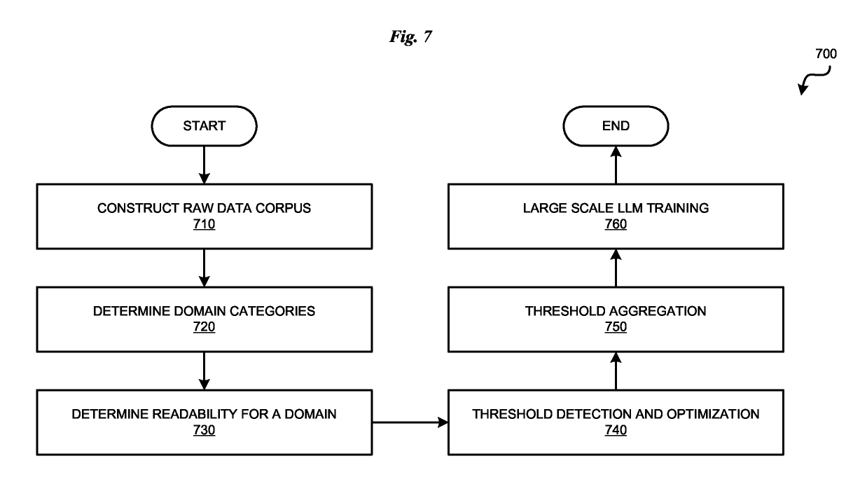

FIG. 7 depicts a flow chart of an implementation of filtering for improving data quality in training large language models in accordance with an illustrative embodiment. In a particular embodiment, the components of diagram 700 show aspects of the Application 200 of FIG. 1.

In the illustrated embodiment, the process begins by constructing a raw data corpus at 710. For example, raw data corpus described herein may be sourced from any type and number of data sources, for example, data mart and/or Internet or other raw data source. One or more domains are identified in raw data corpus to form raw domain data such as education, technology & computing, medical health and/or science. For example, raw domain data may comprise raw data pertaining to domain 1 through domain n. Raw domain data is a further optional form of raw domain data in which one or more categories and one or more subcategories have been identified and appropriately flagged or marshaled. For example, raw domain data is shown to include categories A-X for domain 1, and so on till domain n having categories P-T with category T having subcategories (i)-(x), and so on.

At step 720, the process determines domain categories. For example, a domain sampling component of a system, executes a sampling instruction, the executing causing sampling of raw data to form sample domain data, the sample domain data representative of data pertaining to a domain, wherein the sample domain data comprises a set of documents. In an example, one embodiment uses a clustering technique to identify one or more categories in which the raw domain data of a particular domain might be separated. In another example, multiple trained fastText classifiers are used. A data sampler samples the raw domain data of a domain to extract a representative sample of the raw domain data of the domain.

At step 730, the process determines readability of documents for each domain. A readability metric may be a readability metric using techniques such as Mcalpile EFLaw, which may be used as a reference readability metric, and/or other available techniques including but not limited to Gunning Fog, Flesch Kincaid Grade Level, and/or Automated Readability Index (ARI). The readability metric including a score from the formula is then interpreted as an approximate grade level required for a reader to comprehend the text. Based on the readability metric of the set of documents, a statistical distribution, including but not limited to Gaussian, bell-shaped normal distribution, chi-square distribution and/or histograms of the set of documents is established.

At step 740, the process computes threshold detection and optimization. In an embodiment, a component of the system detects, and determines from the statistical distribution a plurality of thresholds, the plurality of thresholds including the threshold and a second threshold. Starting from initial threshold values and subsequently using iteratively revised threshold values, the documents at the extremes of the distributions are removed at each iteration using threshold aggregation.

In embodiments, a component of the system captures, from the statistical distribution, a subset of documents such that each member of the subset has a value of the corresponding readability metric, and the value is below a first threshold configured for the statistical distribution.

Component extracts the documents that are in the extremes and produces interim filtered data. Component uses test LLM to determine whether the interim filtered data improves an output of test LLM. In embodiments, a computational component is configured to operate with the LLM causing the LLM to iteratively execute a training instruction on the sample domain data, the executing outputting a performance metric. For example, specially purposed training instruction may interact with a training interface of the test LLM.

The test LLM is modified responsive to the performance metric being improved compared to a performance threshold, wherein the performance threshold is based on a benchmark dataset. If the test LLM provides a machine learning feedback such as a performance metric that the performance has improved, component may further tune a threshold to try and further improve the performance until the improvements either reverse or stagnate. For example, determining the performance metric being improved compared to a performance threshold comprises computing a statistical distance between the performance metric and the performance threshold. In embodiments, a performance threshold is determined using a known benchmark dataset such as FineWeb. Computing a statistical distance may include known techniques such as Kullback–Leibler divergence. Similarly, if the test LLM provides a machine learning feedback that the performance has deteriorated, component may roll back a threshold to a previous value or a different value to try and improve the performance.

At step 750, a threshold aggregator aggregates the thresholds for various readability scores operating on the same domain data to order or distribute the documents in an aggregate manner. Iterative threshold revisions to one or more thresholds are computed in operations and utilized to arrive at optimized values of one or more thresholds, as the case may be depending on the number of domains in the data, type of distribution(s) used, readability scores used, or some combination of these and other factors. Once thresholds have been optimized for all the different distributions for all the different readability metrics for a given domain data, the process aggregates the threshold values for that sample domain data.

A revised set of low-quality documents are filtered out and the process performed in another iteration. When the performance of the test LLM remains unchanged, to wit, not changing by more than a tolerance value in either direction relative to the performance in the previous iteration, the last used threshold value(s) are output as optimal threshold(s).

The computational component is further configured to cause adjustment of a parameter, such as weights and biases of the test LLM based at least on a difference between the sample domain data, such as the current filtered data set, and a previous sample domain data, such as a previous filtered data set.

Once the performance of test LLM is determined to be satisfactory, or further improvements not computationally desirable, component outputs a final version of filtered data in the form of filtered data. Filtered data is then usable for training production LLM at step 760. The process then ends. Note that although the steps are depicted separately, the steps may also be combined in embodiments described herein.

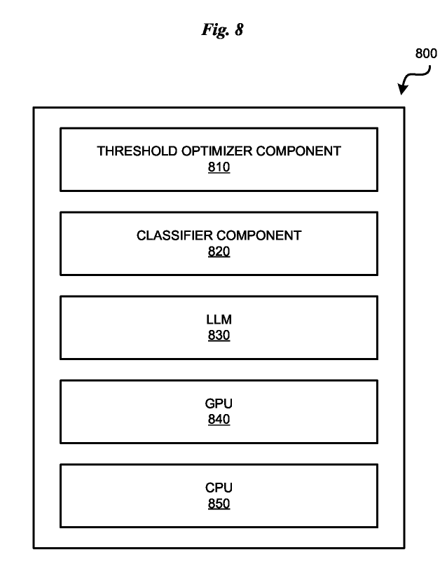

FIG. 8 depicts a system diagram of an implementation of filtering for improving data quality in training large language models in accordance with an illustrative embodiment. In a particular embodiment, the components of diagram 800 show aspects of the Application 200 of FIG. 1.

In the illustrated embodiment, the system comprises a threshold optimizer component 810, a classifier component 820, a LLM 830, a network component, a general processing unit (GPU) 840, a central processing unit 850 and various other component including but not limited to a data store, a data sampler component, a domain sampling component and a computational component. For example, the network component may comprise a network adaptor, a socket, a graphics card, one or more routers, switches, hubs, and/or other network connectivity devices. The network component may transmit and/or receive data via network links such as data may be transmitted and/or received using Wireless Application Protocol (WAP), Multimedia Messaging Service (MMS), Enhanced Messaging Service (EMS), Short Message Service (SMS), Global System for Mobile Communications (GSM) based systems, Code Division Multiple Access (CDMA) based systems, Transmission Control Protocol/Internet Protocols (TCP/IP), or other protocols and/or systems suitable for transmitting and receiving data. Data may be transmitted and/or received wirelessly or may utilize cabled network connections or telecom connections such as an Ethernet RJ45/Category 5 Ethernet connection, a fiber connection, a traditional phone wireline connection, a cable connection or other wired network connection.

The LLM 830 may comprise a neural network with an encoder-decoder architecture accepting input feature vectors to the machine learning model to perform predictions. The LLM may further comprise a training interface, an output interface, and a fine-tuning interface. Neural network parameters, like weights and biases, are the adjustable values that determine the network's behavior and are learned during training. These parameters can be implemented in hardware, particularly using Field-Programmable Gate Arrays (FPGAs) and specialized hardware like Application-Specific Integrated Circuits (ASICs), for efficient computation. The parameters (weights and biases) are essentially numerical values that determine the strength of connections between neurons in the network. They are stored in hardware memory (e.g., Static Random Access Memory (SRAM) in FPGAs or ASICs).

GPU 840 due to their ability to process tasks simultaneously, may be used for training the neural networks. By conducting numerous calculations at the same time, they can greatly decrease the processing time needed for the large volumes of data that machine learning models use. Tensor Processing Units, on the other hand, created specifically for executing machine learning tasks. Their ability to provide increased efficiency and speed while working with neural networks makes them a transformative technology for training machine learning models.

A physical data storage device is the underlying technology behind a data store. The data store may comprise a data store interface that receives a provision instruction, its execution causing the data store to provision resources such as a start node queue, an end node queue, files, tables, or blocks stored on a device. The device can be local, remote, or in the cloud. Large data stores are typically distributed across multiple physical devices in different geographic locations. Software systems and services abstract the underlying operations of the data store. Different types of data storage devices provide varying degrees of security and redundancy. A solid-state drive (SSD) is a semiconductor technology that allows the writing and reading of data in flash memory chips. Flash storage technology was commercially available in pen drives before becoming an alternative to hard disk drives (HDD). Compared to an HDD, a physical SSD has no moving parts, which means it has faster performance and a longer lifespan. Hybrid storage array is a physical storage setup that consists of an SSD and an HDD. While an SSD offers a low-latency operation, it costs much more per-unit storage than an HDD. Therefore, organizations use a hybrid storage array to balance performance, capacity, and cost. RAID stands for a redundant array of independent disks. It is a technology that keeps the same data in multiple places on an SSD.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ± 8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
executing, a specially purposed sampling instruction by a domain sampling component, causing sampling of raw data to form sample domain data, wherein the sample domain data comprises a set of documents;
establishing, a statistical distribution of the set of documents, according to a readability metric of each document in the set of documents based on a domain;
configuring, a computational component to operate with a machine learning model causing the machine learning model to iteratively execute a specially purposed training instruction on the sample domain data, the executing outputting a performance metric;
modifying, the machine learning model responsive to the performance metric being compared to a performance threshold, wherein the performance threshold is based on a benchmark dataset;
capturing, from the statistical distribution, a subset of documents such that each
member of the subset has a value of a corresponding readability metric, and the value is below a first threshold configured for the statistical distribution;
filtering, the subset of documents from the sample domain data such that a second
subset comprising documents remaining in the sample domain data after the filtering comprises filtered data; and
further configuring the computational component to cause adjustment of a parameter of the machine learning model based at least on a difference between the filtered data and a previous sample domain data.

2. The computer-implemented method of claim 1, wherein the first threshold is based on an aggregation of thresholds wherein each of the aggregated thresholds is associated with the statistical distribution across the domain in a set of domains.

3. The computer-implemented method of claim 1, further comprising:
revising the first threshold to form a revised threshold; and
using, in the capturing, the revised threshold as the first threshold, the using causing a
different subset of documents from the set of documents such that a first document is not a
member of the different subset.

4. The computer-implemented method of claim 1, further comprising:
determining from the performance metric that the first threshold is an optimal
threshold;
filtering, using the optimal threshold, to form new filtered data, new domain data
comprising a new set of documents; and
training a second model using the new filtered data.

5. The computer-implemented method of claim 1, wherein determining the performance metric being improved compared to the performance threshold comprises computing a statistical distance between the performance metric and the performance threshold.

6. The computer-implemented method of claim 1, wherein the statistical distribution is
configured with a plurality of thresholds, the plurality of thresholds including the first threshold
and a second threshold.

7. The computer-implemented method of claim 1, further comprising configuring the first threshold for the statistical distribution based on the performance metric received from the machine learning model, the performance metric being related to a performance of the machine learning model after being trained using the filtered data.

8. A computer program product comprising one or more computer readable storage media, and program instructions collectively stored on the one or more computer readable storage media, the program instructions executable by a processor to cause the processor to perform operations comprising:
executing, a specially purposed sampling instruction by a domain sampling component, causing sampling of raw data to form sample domain data, wherein the sample domain data comprises a set of documents;
establishing, a statistical distribution of the set of documents, according to a readability metric of each document in the set of documents based on a domain;
configuring, a computational component to operate with a machine learning model causing the machine learning model to iteratively execute a specially purposed training instruction on the sample domain data, the executing outputting a performance metric;
modifying, the machine learning model responsive to the performance metric being compared to a performance threshold, wherein the performance threshold is based on a benchmark dataset;
capturing, from the statistical distribution, a subset of documents such that each
member of the subset has a value of a corresponding readability metric, and the value is below a first threshold configured for the statistical distribution;
filtering, the subset of documents from the sample domain data such that a second
subset comprising documents remaining in the sample domain data after the filtering comprises filtered data; and
further configuring the computational component to cause adjustment of a parameter of the machine learning model based at least on a difference between the filtered data and a previous sample domain data.

9. The computer program product of claim 8, wherein the first threshold is based on an aggregation of thresholds wherein each of the aggregated thresholds is associated with the statistical distribution across the domain in a set of domains.

10. The computer program product of claim 8, further comprising:
revising the first threshold to form a revised threshold; and
using, in the capturing, the revised threshold as the first threshold, the using causing a
different subset of documents from the set of documents such that a first document is not a
member of the different subset.

11. The computer program product of claim 8, further comprising:
determining from the performance metric that the first threshold is an optimal
threshold;
filtering, using the optimal threshold, to form new filtered data, new domain data
comprising a new set of documents; and
training a second model using the new filtered data.

12. The computer program product of claim 8, wherein determining the performance metric being improved compared to the performance threshold comprises computing a statistical distance between the performance metric and the performance threshold.

13. The computer program product of claim 8, wherein the statistical distribution is
configured with a plurality of thresholds, the plurality of thresholds including the first threshold and a second threshold.

14. The computer program product of claim 8, further comprising configuring the first threshold for the statistical distribution based on the performance metric received from the machine learning model, the performance metric being related to a performance of the machine learning model after being trained using the filtered data.

15. A computer system comprising a processor and one or more computer readable storage media, and program instructions collectively stored on the one or more computer readable storage media, the program instructions executable by the processor to cause the processor to perform operations comprising:
executing, a specially purposed sampling instruction by a domain sampling component, causing sampling of raw data to form sample domain data, wherein the sample domain data comprises a set of documents;
establishing, a statistical distribution of the set of documents, according to a readability metric of each document in the set of documents based on a domain;
configuring, a computational component to operate with a machine learning model causing the machine learning model to iteratively execute a specially purposed training instruction on the sample domain data, the executing outputting a performance metric;
modifying, the machine learning model responsive to the performance metric being compared to a performance threshold, wherein the performance threshold is based on a benchmark dataset;
capturing, from the statistical distribution, a subset of documents such that each
member of the subset has a value of a corresponding readability metric, and the value is below a first threshold configured for the statistical distribution;
filtering, the subset of documents from the sample domain data such that a second
subset comprising documents remaining in the sample domain data after the filtering comprises filtered data; and
further configuring the computational component to cause adjustment of a parameter of the machine learning model based at least on a difference between the filtered data and a previous sample domain data.

16. The computer system of claim 15, wherein the first threshold is based on an aggregation of thresholds wherein each of the aggregated thresholds is associated with the statistical distribution across the domain in a set of domains.

17. The computer system of claim 15, further comprising:
revising the first threshold to form a revised threshold; and
using, in the capturing, the revised threshold as the first threshold, the using causing a
different subset of documents from the set of documents such that a first document is not a
member of the different subset.

18. The computer system of claim 15, further comprising:
determining from the performance metric that the first threshold is an optimal
threshold;
filtering, using the optimal threshold, to form new filtered data, new domain data
comprising a new set of documents; and
training a second model using the new filtered data.

19. The computer system of claim 15, wherein determining the performance metric being improved compared to the performance threshold comprises computing a statistical distance between the performance metric and the performance threshold.

20. The computer system of claim 15, wherein the statistical distribution is
configured with a plurality of thresholds, the plurality of thresholds including the first threshold and a second threshold.
